(19) United States
(12) Patent Application Publication
(10) Pub. No.: US 2012/0066283 A1
(43) Pub. Date: Mar. 15, 2012

(54) DIVIDER AND METHOD OF OPERATING THE SAME

(75) Inventors: Dae Soon CHO, Daejeon (KR); Daeho KIM, Daejeon (KR)

(73) Assignee: Electronics and Telecommunications Research Institute, Daejeon (KR)

(21) Appl. No.: 13/222,108

(22) Filed: Aug. 31, 2011

(30) Foreign Application Priority Data
Sep. 13, 2010 (KR) 10-2010-0089620

(51) Int. Cl. G06F 7/52

(52) U.S. Cl. 708/650

(57) ABSTRACT

Provided are a divider having a small area and an improved operation speed and a method of operating the same. The divider includes a memory, a controller, and a multiplier. The memory is configured to store table values included in a predetermined range. The controller is configured to receive a divisor, generate an address expressed in a plurality of bits according to the bits except the most significant bit of the divisor, and receive the table value corresponding to the address from the memory. The multiplier is configured to receive a dividend and calculate an initial value by multiplying the dividend and the table value corresponding to the address. Herein, the controller determines an exponent of the divisor and right-shifts the initial value by the exponent of the divisor.

### CROSS-REFERENCE TO RELATED APPLICATIONS

This U.S. non-provisional patent application claims priority under 35 U.S.C. §119 of Korean Patent Application No. 10-2010-0089620, filed on Sep. 13, 2010, the entire contents of which are hereby incorporated by reference.

### BACKGROUND OF THE INVENTION

The present invention disclosed herein relates to a divider and a method of operating the same, and more particularly, to a divider including a memory and a method of operating the same.

In a MIMO (Multi Input Multi Output) transmitting/receiving (TX/RX) scheme, if an RX terminal uses an MMSE (Minimum Mean-Squared Error) receiving method, the complexity of hardware for implementation of the RX terminal increases with an increase in the number of TX/RX antennas. In particular, the number of dividers for calculation of an inverse matrix in the RX terminal increases rapidly with an increase in the number of antennas. For example, a 4×4 MIMO TX/RX scheme requires calculating a 4×4 inverse matrix in the RX terminal. An 8×8 MIMO TX/RX scheme requires calculating an 8×8 inverse matrix in the RX terminal. Herein, the divider performs a floating-point division operation.

That is, a floating-point division operation is performed to calculate the inverse matrix. The floating-point division operation requires the longest calculation time among the 4 basic arithmetic operations. Thus, the floating-point division operation may degrade the operation performance of the RX terminal. What is therefore required is a divider that can reduce the inverse matrix calculation time in order to improve the operation performance of the RX terminal.

### SUMMARY OF THE INVENTION

The present invention provides a divider having a small area and an improved operation speed and a method of operating the same.

In some embodiments of the present invention, a method of operating a divider includes: storing a look-up table including a predetermined range of values; determining an exponent of a divisor received from an external, and obtaining one of the values included in the look-up table, on the basis of the bits except the most significant bit of the divisor; calculating an initial value by multiplying one of the values included in the look-up table and a dividend received from an external; and shifting the initial value by the exponent of the most significant bit.

In some embodiments, the obtaining of one of the values included in the look-up table includes obtaining one of the values included in the look-up table, on the basis of the lower bits with respect to the most significant bit.

In other embodiments, the look-up table includes an address corresponding to each of the values included in the look-up table, and the values corresponding to the address decrease as the value of the address increases.

In further embodiments, the obtaining of one of the values included in the look-up table includes determining the address according to the value of the bits except the most significant bit.

In still further embodiments, the values included in the look-up table have a prescribed scale, and the right-shifting of the initial value includes right-shifting the initial value by the number of bits corresponding to the prescribed scale.

In other embodiments of the present invention, a divider includes: a memory configured to store table values included in a predetermined range; a controller configured to receive a divisor, generate an address expressed in a plurality of bits according to the bits except the most significant bit of the divisor, and receive the table value corresponding to the address from the memory; and a multiplier configured to receive a dividend and calculate an initial value by multiplying the dividend and the table value corresponding to the address, wherein the controller determines an exponent of the divisor and right-shifts the initial value by the exponent of the divisor.

In some embodiments, the controller generates the address according to the lower bits of the most significant bit of the divisor. Herein, the controller may generate the bits of the divisor, corresponding to the number of bits expressing the address, as the address.

In other embodiments, the memory stores the table values having a prescribed scale, and the controller right-shifts the initial value by the number of bits corresponding to the prescribed scale. The memory may store the table values such that the value obtained by dividing the table values by the prescribed scale is greater than about 0.5 and equal to or smaller than about 1.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a graph illustrating the relationship between a divisor and a reciprocal of the divisor;

FIG. 2 is a block diagram of a divider according to an exemplary embodiment of the present invention;

FIG. 3 illustrates a first example of the look-up table stored in the memory of FIG. 2;

FIG. 4 illustrates a second example of the look-up table stored in the memory of FIG. 2;

FIG. 5 is a flow chart illustrating a process of performing a division operation in the divider of FIG. 2;

FIG. 6 illustrates an example of the operation of determining a reciprocal of a divisor in step S120 of FIG. 5; and

FIGS. 7 to 9 illustrate an example of the operation of determining an address on the basis of the divisor in step S120 of FIG. 5.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the specification and drawings, like reference numerals denote like elements.

Throughout the disclosure, when one element (or component, unit, part, etc.) is referred to as being ‘connected’ to another element (or component, unit, part, etc.), it should be understood that the former may be ‘directly connected’ to the latter, or ‘indirectly (or electrically) connected’ to the latter through at least one intervening element (or component, unit, part, etc.). Also, when one element is referred to as comprising (or including or having) some elements, it should be understood that the element may comprise (or include or have) other elements as well as those elements, unless otherwise specified.

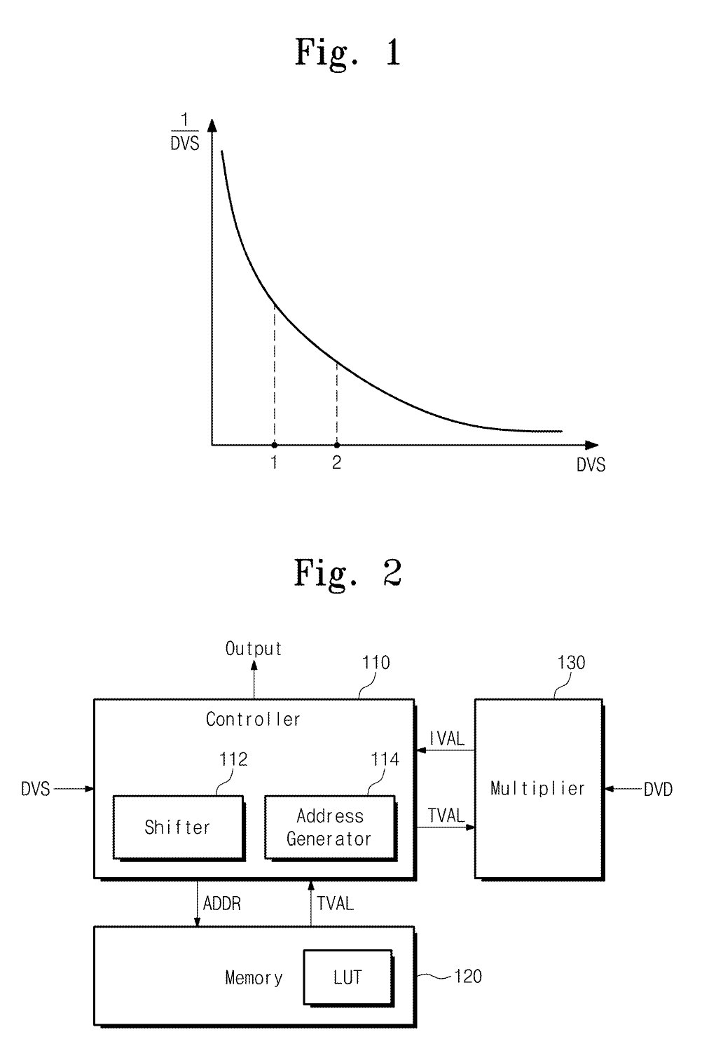

FIG. 1 is a graph illustrating the relationship between a divisor DVS and a reciprocal of the divisor DVS.

Referring to FIG. 1, the axis of abscissas represents the value of a divisor DVS and the axis of ordinates represents the value of a reciprocal of the divisor DVS. Hereinafter, a reciprocal of a divisor DVS will be referred to as a multiplicative inverse.

A division operation is performed by dividing a dividend by the divisor DVS. A division operation may be performed by multiplying a dividend by a multiplicative inverse. Herein, the multiplicative inverse may be prestored. A division operation is performed by multiplying a dividend by the prestored multiplicative inverse.

However, it may be difficult to store all ranges of multiplicative inverses. In this case, considering only divisors DVS equal to or greater than about 1 and smaller than about 2, only multiplicative inverses greater than about 0.5 and equal to or smaller than about 1 may be stored. Also, divisors DVS that are not equal to or greater than about 1 and smaller than about 2 may be controlled to be equal to or greater than about 1 and smaller than about 2. That is, multiplicative inverses that are not greater than about 0.5 and equal to or smaller than about 1 may be controlled to be greater than about 0.5 and equal to or smaller than about 1.

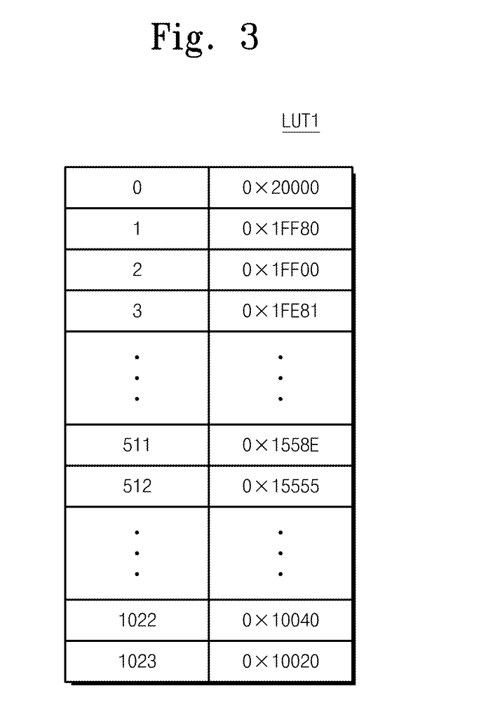

For example, it is assumed that the divisor DVS is 3. Multiplicative inverses greater than about 0.5 and equal to or smaller than about 1 are stored. The multiplicative inverse corresponds to ⅓. In this case, ⅔ obtained by multiplying ⅓ by 2 is greater than about 0.5 and equal to or smaller than about 1. The dividend is multiplied by ⅔. The multiplication result is divided by 2 to obtain a desired calculation result. The multiplication of ⅓ by 2 and the division of the multiplication result by 2 may be performed by a shifting operation. Hereinafter, exemplary embodiments of the present invention will be described in detail with reference to FIGS. 2 to 6.

FIG. 2 is a block diagram of a divider 100 according to an exemplary embodiment of the present invention.

Referring to FIG. 2, the divider 100 includes a controller 110, a memory 120, and a multiplier 130.

The controller 110 is electrically connected to the memory 120 and the multiplier 130. The controller 110 includes a shifter 112 and an address generator 114. The controller 110 receives a divisor DVS for division from an external device.

The address generator 114 generates an address ADDR with reference to the received divisor DVS. The controller 110 transmits the generated address ADDR to the memory 120. The controller 110 may receive a table value TVAL corresponding to the address ADDR from the memory 120. The controller 110 transmits the received table value TVAL to the multiplier 130.

The shifter 112 determines an exponent of the received divisor DVS. For example, the received divisor DVS is right-shifted until it does not include a logic value ‘1’, and 1 is subtracted from the shift count number to determine the exponent of the divisor DVS.

The shifter 112 right-shifts the bits included in an initial value IVAL received from the multiplier 130, as the number of bits corresponding to the scale of a look-up table LUT. The shifter 112 right-shifts the bits included in the initial value IVAL, as the exponent of the divisor DVS.

The memory 120 is electrically connected to the controller 110. The memory 120 stores a look-up table LUT including values corresponding to multiplicative inverses. Herein, the multiplicative inverses are greater than about 0.5 and equal to or smaller than about 1 (hereinafter referred to as a normal range).

The look-up table LUT has a prescribed scale. For example, the look-up table LUT may include values ranging from 2¹⁷ to 2¹⁶. In this case, the look-up table LUT has a scale of 2¹⁷.

The memory 120 receives an address ADDR from the controller 110. The memory 120 provides a table value TVAL corresponding to the received address ADDR to the controller 110.

For example, the memory 120 may include a memory controller (not illustrated). The memory controller may receive an address ADDR, read a table value TVAL corresponding to the received address ADDR, and provide the table value TVAL to the controller 110.

Examples of the memory 120 include ROM (Read Only Memory), PROM (Programmable ROM), EPROM (Electrically Programmable ROM), EEPROM (Electrically Erasable and Programmable ROM), flash memory devices, PRAM (Phase-change RAM), MRAM (Magnetic RAM), RRAM (Resistive RAM), and FRAM (Ferroelectric RAM).

The multiplier 130 is electrically connected to the controller 110. The multiplier 130 receives a dividend DVD from an external device. The multiplier 130 receives a table value TVAL from the controller 110. The multiplier 130 calculates an initial value IVAL by multiplying the dividend DVD and the table value TVAL received from the controller 110. The calculated initial value IVAL is transmitted to the controller 110.

The controller 110 receives the initial value IVAL. The shifter 112 shifts the received initial value IVAL. The controller 110 outputs the shift result value.

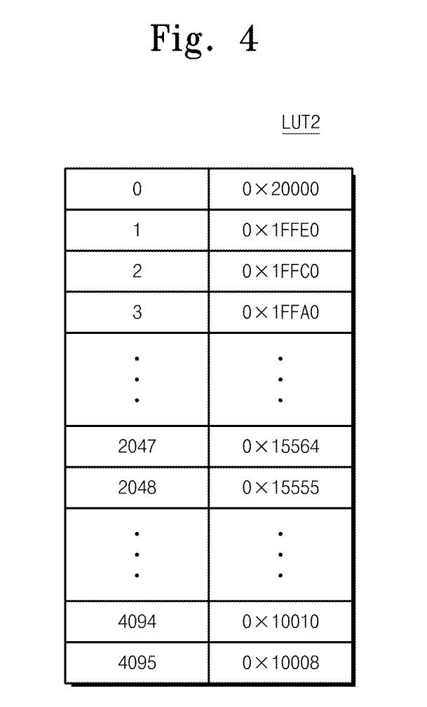

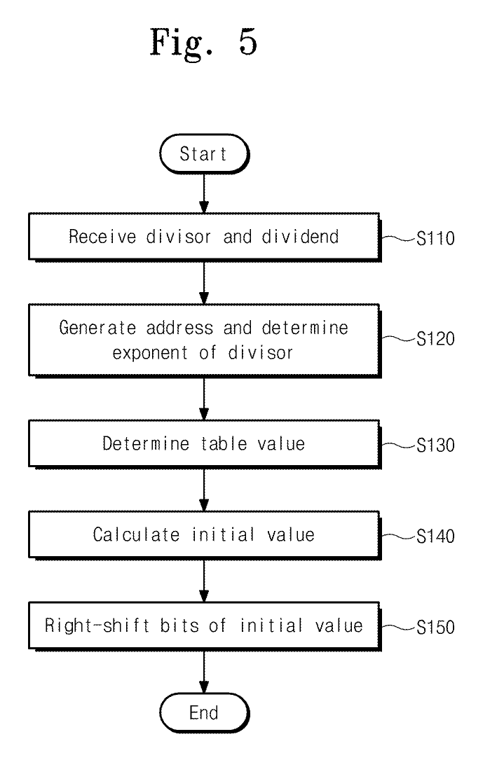

FIG. 3 illustrates a first example LUT1 of the look-up table LUT stored in the memory 120 of FIG. 2. FIG. 4 illustrates a second example LUT2 of the look-up table LUT stored in the memory 120 of FIG. 2. Referring to FIGS. 3 and 4, the first look-up table LUT1 and the second look-up table LUT2 are expressed in hexadecimal.

The memory 120 of FIG. 2 stores values included in a predetermined range. In FIGS. 3 and 4, the first look-up table LUT1 and the second look-up table LUT2 include values ranging from 0x20000 to 0x10000. That is, when the values of FIGS. 3 and 4 are converted into decimal numbers, values ranging from 2¹⁷ to 2¹⁶ are stored in the first look-up table LUT1 and the second look-up table LUT2.

The values stored in the memory 120 correspond to the multiplicative inverses included in the normal range. That is, in the first look-up table LUT1 and the second look-up table LUT2, the values ranging from 2¹⁷ to 2¹⁶ correspond respectively to the values included in the normal range. Herein, the first look-up table LUT1 and the second look-up table LUT2 have a scale of 2¹⁷. When the values included in the first look-up table LUT1 and the second look-up table LUT2 are divided by 2¹⁷, the values included in the normal range are obtained.

The initial value IVAL are calculated by multiplying the dividend DVD and the table value TVAL. Because the table value TVAL having a scale of 2¹⁷ is multiplied by the dividend DVD to calculate the initial value IVAL, the controller 110 right-shifts the initial value IVAL by 17 bits. The right-shifting of the initial value IVAL by 17 bits provides the effect of the dividing the initial value IVAL by 2¹⁷.

The memory 120 has a prescribed resolution. The first look-up table LUT1 has a 10-bit resolution. That is, the first look-up table LUT1 has 2¹⁰ addresses. The 2¹⁰ addresses correspond respectively to the values ranging from 2¹⁶ to 2¹⁷.

The second look-up table LUT2 has a 12-bit resolution. That is, the second look-up table LUT2 has 2¹² addresses. The 2¹² addresses correspond respectively to the values ranging from 2¹⁶ to 2¹⁷. Consequently, the look-up table LUT1 with a higher accuracy is provided as the number of addresses included in the look-up table LUT stored in the memory 120 of FIG. 2 increases.

For example, when generating the first and second look-up tables LUT1 and LUT2, an address and values corresponding to the address are stored according to Equation (1).

$${VALUE}_{i} = [ K \cdot ( \frac{1}{1 + i / R} ) ] 0 \leq i < R \qquad ( 1 )$$

In Equation (1), K denotes the scale of the first look-up table LUT1 or the second look-up table LUT2. R denotes the resolution of the first look-up table LUT1 or the second look-up table LUT2. That is, R in the first look-up table LUT1 may be 10. Also, R in the second look-up table LUT2 may be 12. i denotes an address, and VALUEᵢ denotes a value corresponding to i.

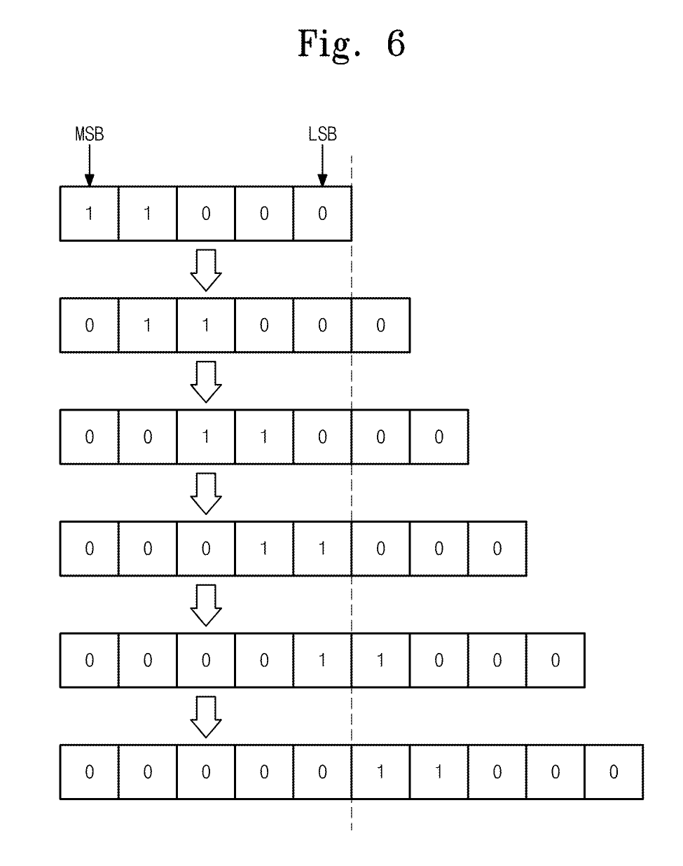

FIG. 5 is a flow chart illustrating a process of performing a division operation in the divider 100 of FIG. 2.

Referring to FIGS. 2 and 5, in step S110, the divider 100 receives the divisor DVS and the dividend DVD. The divisor DVS may be received by the controller 110, and the dividend DVD may be received by the multiplier 130.

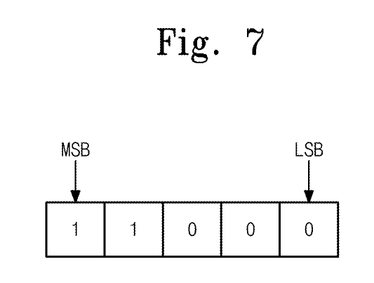

In step S120, the controller 110 generates the address ADDR and determines the exponent. The controller 110 may generate the address ADDR on the basis of the divisor DVS. Even when the divisor DVS is not equal to or greater than about 1 and smaller than about 2, the controller 110 generates the address ADDR corresponding to the value included in the look-up table LUT. This will be described in detail with reference to FIGS. 6 to 8.

The controller 110 determines the exponent of the received divisor DVS. For example, the shifter 112 may determine the exponent of the received divisor DVS by right-shifting the received divisor DVS until it does not include a logic value ‘1’ and subtracting 1 from the shift count number. For example, if the logic value of the divisor DVS is ‘1100’, when the logic value ‘1100’ is right-shifted until it does not include a logic value ‘1’, the shift count number is 4. In this case, the exponent is ‘3’. This will be described in detail with reference to FIG. 9.

In step S130, the table value TVAL is determined. The memory 120 transmits the table value TVAL, which corresponds to the address ADDR received from the controller 110, to the controller 110. Consequently, the divisor DVS is mapped to the value included in the look-up table LUT. The controller 110 transmits the received table value TVAL to the multiplier 130.

In step S140, the table value TVAL and the dividend DVD are multiplied to calculate the initial value IVAL. The initial value IVAL calculated by the multiplier 130 is transmitted to the controller 110.

In step S150, the shifter 112 shifts the bits included in the initial value IVAL. The bits included in the initial value IVAL are right-shifted on the basis of the exponent of the divisor and the scale of the look-up table LUT.

The look-up table LUT has a prescribed scale. For example, the look-up table LUT including values ranging from 2¹⁷ to 2¹⁶ has a scale of 2¹⁷. The initial value IVAL is right-shifted by the number of bits corresponding to the scale of the look-up table LUT, thereby achieving the effect of dividing the initial value IVAL by the scale of the look-up table LUT.

Not only the divisor DVS that is equal to or greater than about 1 and smaller than about 2, but also the divisor DVS that is not equal to or greater than about 1 and smaller than about 2, are mapped in the look-up table LUT. On the other hand, the look-up table LUT stores only the values corresponding to the multiplicative inverses included in the normal range. When the divisor DVS that is not equal to or greater than about 1 and smaller than about 2 is mapped to any one value of the look-up table, the calculated initial value IVAL is divided by a predetermined number. Thus, the bits included in the initial value IVAL are right-shifted by the exponent of the divisor DVS.

FIG. 6 illustrates an example of the operation of determining the reciprocal of the divisor DVS in step S120 of FIG. 5.

In the following description of FIGS. 6 to 9, it is assumed that the dividend DVS is ‘11000’. Also, it is assumed that the resolution of the look-up table LUT is 10 bits. Although the divider 100 may receive the divisor DVS including more than about 5 bits, the left bits of a logic value ‘11000’ are omitted for conciseness.

Referring to FIG. 6, the bits constituting the divisor DVS are right-shifted until there is no logic value ‘1’. The shifter 112 of FIG. 2 right-shifts the bits constituting the divisor DVS. The bits constituting the divisor DVS may be right-shifted by five times. The controller 110 of FIG. 2 determines the exponent of the divisor DVS as 4 that is obtained by subtracting 1 from the shift count number. Consequently, the exponent of the divisor DVS is determined according to the exponent of the most significant bit MSB among the bits constituting the divisor DVS. For example, the divisor DVS has a logical value of ‘11000’, the MSB corresponds to a decimal number ‘16’ and the exponent is 4.

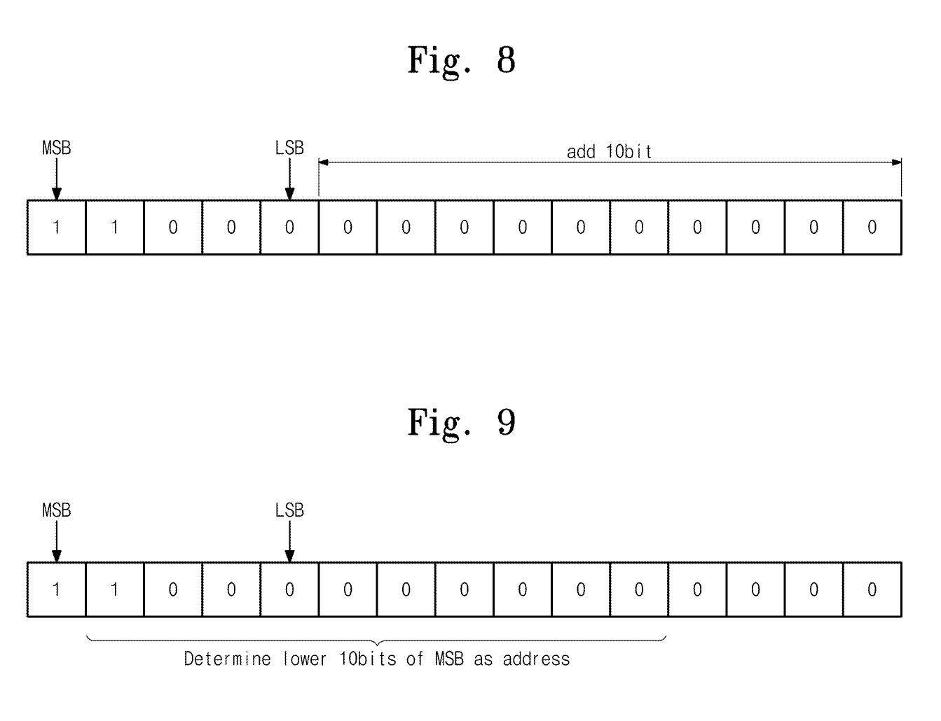

FIGS. 7 to 9 illustrate an example of the operation of determining the address ADDR on the basis of the divisor DVS in step S120 of FIG. 5.

Referring to FIG. 7, the most significant bit MSB among the bits constituting the divisor DVS is the fifth bit. The least significant bit LSB among the bits constituting the divisor DVS is the first bit.

In FIG. 8, the bits corresponding to the resolution of the first look-up table LUT1 are added to the right side of the least significant bit LSB among the bits constituting the divisor DVS. That is, the lower 10 bits are added to the right with respect to the least significant bit LSB among the bits constituting the divisor DVS. For example, if a logic value ‘11000’ is left-shifted by 10 bits, the lower 10 bits may be added to the right with respect to the least significant bit LSB. Herein, the shifter 112 of FIG. 2 may left-shift the logic value ‘11000’ by 10 bits.

In FIG. 9, the lower bits as many as the number of bits corresponding to the resolution of the first look-up table LUT1 with respect to the most significant bit MSB among the bits constituting the divisor DVS are determined as the address ADDR. That is, the lower 10 bits with respect to the most significant bit MSB are determined as the address ADDR. The controller 110 transmits the determined address ADDR to the memory 120.

As described with reference to FIGS. 8 and 9, the divisor DVS equal to or greater than about 1 and smaller than about 2 may also be mapped in the look-up table LUT. The table value TVAL is determined according to the determined address ADDR except the most significant bit MSB and the initial value is determined according to the table value TVAL. Therefore, the initial value IVAL is right-shifted by the exponent of the most significant bit MSB.

The logic value ‘11000’ received as the divisor DVS corresponds to a decimal number ‘24’. The decimal number ‘24’ is not greater than or equal to about 1 and smaller than about 2. According to an exemplary embodiment of the present invention, in order to map the divisor DVS, which does not range from 1 to 2, to the look-up table LUT, the lower bits as many as the number of bits corresponding to the resolution of the first look-up table LUT1 with respect to the most significant bit MSB are determined as the address ADDR. When the address ADDR is determined except the most significant bit MSB, the calculated initial value IVAL is right-shifted by the exponent of the divisor DVS. Because the scale value of the first look-up table LUT1 is reflected in the initial value IVAL, the bits constituting the initial value IVAL are right-shifted by the number of bits corresponding to the scale of the first look-up table LUT1.

In FIG. 9, the lower 10 bits with respect to the most significant bit MSB among the bits constituting the divisor DVS has a logic value of ‘1000000000’. The logic value ‘1000000000’ corresponds to a decimal number ‘2⁹’. Referring to FIG. 3, the 512^{th} address of the first look-up table LUT1 corresponds to ‘0x15555’. The memory 120 transmits the table value TVAL ‘0x15555’ to the controller 110. The controller 110 transmits the table value TVAL ‘0x15555’ to the multiplier 130.

It is assumed that the dividend DVD is a decimal number ‘10000’. The table value TVAL ‘0x15555’ corresponds to a decimal number ‘87381’. A decimal number ‘10000’ multiplied by a decimal number ‘87381’ is ‘873810000’. The controller 110 receives the bits corresponding to a decimal number ‘873810000’ that is the initial value IVAL. The controller 110 right-shifts the bits of the initial value IVAL by the exponent of the divisor DVS. That is, the controller 110 right-shifts the bits of the initial value IVAL by 4 bits. The controller 110 right-shifts the bits of the initial value IVAL by the bits corresponding to the scale of the first look-up table LUT1. That is, the controller 110 right-shifts the bits of the initial value IVAL by 17 bits. Consequently, the bits of the initial value IVAL are right-shifted by 21 bits. A decimal number ‘873810000’ (i.e., the initial value IVAL) divided by a decimal number ‘2²¹’ equals about ‘416.66508’. A decimal number ‘10000’ divided by a decimal number ‘24’ equals about ‘416.66667’.

According to an exemplary embodiment of the present invention, the look-up table including the values corresponding to the multiplicative inverses of the normal range is stored in the memory 120. The divisor DVS not included in the normal range is normalized and mapped to the value stored in the memory 120. Thus, the divider 100 has a high operation speed and requires a small storage space.

As described above, the present invention can provide a divider having a small area and an improved operation speed and a method of operating the same.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of operating a divider, comprising:
storing a look-up table including a predetermined range of values;
determining an exponent of a divisor received from an external, and obtaining one of the values included in the look-up table on the basis of the bits except the most significant bit among the bits of the divisor;
calculating an initial value by multiplying the obtained value and a dividend received from an external; and
shifting the initial value by the exponent of the divisor.

2. The method of claim 1, wherein the values included in the look-up table correspond to values that are greater than about 0.5 and equal to or smaller than about 1.

3. The method of claim 1, wherein the obtaining of one of the values included in the look-up table comprises determining an exponent of the most significant bit of the divisor.

4. The method of claim 1, wherein the obtaining of one of the values included in the look-up table comprises:
determining an address according to the value of the bits except the most significant bit; and
obtaining one of the values included in the look-up table,
wherein one of the values included in the look-up table is corresponded to the determined address.

5. The method of claim 4, wherein the value corresponding to the address decreases as the value of the address increases.

6. The method of claim 1, wherein
the values included in the look-up table have a prescribed scale, and
the shifting of the initial value comprises right-shifting the initial value according to the number of bits corresponding to the prescribed scale and the exponent of the divisor.

7. The method of claim 6, wherein the value obtained by dividing the predetermined range of values by the prescribed scale is greater than about 0.5 and equal to or smaller than about 1.

8. A divider comprising:
a memory configured to store table values included in a predetermined range;
a controller configured to receive a divisor, generate an address expressed in a plurality of bits according to the bits except the most significant bit of the divisor, and receive the table value corresponding to the address from the memory; and
a multiplier configured to receive a dividend and calculate an initial value by multiplying the dividend and the table value corresponding to the address,
wherein the controller determines an exponent of the divisor and shifts the initial value by the exponent of the divisor.

9. The divider of claim 8, wherein the table value corresponding to the address decreases as the value of the address increases.

10. The divider of claim 8, wherein the memory transmits the table value corresponding to the address to the controller.

11. The divider of claim 8, wherein the controller generates the bits of the divisor, corresponding to the number of bits expressing the address, as the address.

12. The divider of claim 8, wherein the controller generates the upper bits, corresponding to the number of bits expressing the address among the bits except the most significant bit of the divisor, as the address.

13. The divider of claim 8, wherein
the memory stores the table values having a prescribed scale, and
the controller right-shifts the initial value according to the exponent of the divisor and the number of bits corresponding to the scale.

14. The divider of claim 13, wherein the memory stores the table values such that the value obtained by dividing the table values by the prescribed scale is greater than about 0.5 and equal to or smaller than about 1.

15. The divider of claim 13, wherein the memory stores the table values to satisfy an equation
$${VALUE}_{i} = [ K \cdot ( \frac{1}{1 + i / R} ) ] 0 \leq i < R ,$$
where K denotes the scale, R denotes the resolution according to a plurality of bits representing the address, i denotes the address, and VALUEᵢ denotes the table value corresponding to the address.

16. The divider of claim 8, wherein the controller determines the exponent of the most significant bit of the divisor as the exponent of the divisor.

17. The divider of claim 8, wherein the controller right-shifts the initial value by the exponent of the divisor.
